(19) United States
(12) Patent Application Publication
(10) Pub. No.: US 2026/0348332 A1
(43) Pub. Date: Nov. 5, 2026

(54) SYSTEMS AND METHODS FOR CONTROL OF A COMBUSTION SYSTEM

(71) Applicant: NET Power LLC, Durham, NC (US)

(72) Inventors: Scott Thomas Martin, Salt Lake City, UT (US); Shaun McKay, Baton Rouge, LA (US); Robert Krumm, Meridian, ID (US)

(73) Assignee: NET Power LLC, Durham, NC (US)

(21) Appl. No.: 19/549,329

(22) Filed: Feb. 25, 2026

Related U.S. Application Data
(60) Provisional application No. 63/764,370, filed on Feb. 27, 2025.

(51) Int. Cl. F02C 9/28; F02C 3/34; F02C 7/141

(52) U.S. Cl. CPC F02C 9/28; F02C 3/34; F02C 7/141; F05D 2260/213; F05D 2270/112; F05D 2270/303; F05D 2270/3061; F05D 2270/3062

(57) ABSTRACT

Methods and systems for controlling temperature of a combustion system. Flow of temperature control streams to the combustor, to the turboexpander, and to the heat exchanger maintain ΔT into the heat exchanger to avoid damage, maintain flame temperature of the combustor, and maintain turboexpander inlet temperature to avoid damage.

### CROSS-REFERENCE TO RELATED APPLICATIONS

This application claims the benefit of U.S. Provisional Patent Application No. 63/764,370, filed Feb. 27, 2025 and entitled “Systems and Methods for Control of a Combustion System,” the entire contents of which are incorporated by reference herein.

### TECHNICAL FIELD

The present disclosure relates to systems and methods for controlling a combustor.

### BACKGROUND

Combustion systems, including the Allam Cycle, may utilize a carbonaceous fuel, an oxidant stream, and a recycled carbon dioxide stream to produce energy. The oxidant and recycle streams require energy inputs to produce. For certain details of the Allam Cycle, see U.S. Pat. No. 8,596,075, the entire contents of which are incorporated by reference herein.

### SUMMARY

In some examples, the present disclosure provides a temperature-control system for controlling a combustion system. The combustion system includes a combustor to combust a fuel stream with an oxidant stream to produce a first working fluid stream at a temperature T1, a turboexpander to use the first working fluid stream to generate work and a second working fluid stream at a temperature T2, and a heat exchanger to receive the second working fluid stream at a temperature T3 and to cool the second fluid working stream to generate a product working fluid stream. The system includes a first flow controller to control a flow of a first temperature control stream (m1) to the combustor. The system includes a second flow controller to control a flow of a second temperature control stream (m2) to the turboexpander. The system includes a third flow controller to control a flow of a third temperature control stream (m3) to the heat exchanger. The system includes a controller to calculate a rate of change of T3 (ΔT3); and control one or more of m1, m2, and m3 to: (i) maintain a change in T3 (ΔT3) at a sufficiently low value to avoid damaging the heat exchanger, (ii) maintain T1 at a sufficiently high value to maintain flame in the combustor, and (iii) maintain T2 at a sufficiently low value to avoid damaging the turboexpander.

In some examples, the system includes a fuel flow controller to control a flow of the fuel stream (mF) to the combustor. In some examples, the oxidant stream is formed using an oxygen flow controller to control a flow of the oxidant stream (mO) to the combustor.

In some examples, the combustor is an oxy-fuel combustor.

In some examples, the controller further is to control one or more of the fuel flow controller and oxygen flow controller, to maintain an equivalence ratio between the fuel stream and the oxidant stream in the combustor.

In some examples, the controller further is to control mF, mO, or both mF and mO, to maintain a flame temperature Tflame before mixing mF and mO with m1.

In some examples, at least two of the first temperature control stream, the second temperature control stream, and the third temperature control stream include portions of a coolant stream.

In some examples, the coolant stream is at a temperature of at most 300 °C, at most 400 °C, or at most 500 °C.

In some examples, the heat exchanger further is to cool the second working fluid stream by indirect contact heat exchange against a coolant stream.

In some examples, the coolant stream includes the product working fluid stream.

In some examples, the heat exchanger further is to cool the second working fluid stream by indirect contact heat exchange against the oxidant stream.

In some examples, the system includes one or more of a first sensor to measure T1 and transmit T1 to the controller; a second sensor to measure T2 and transmit T2 to the controller; and a third sensor to measure T3 and transmit T3 to the controller.

In some examples, the controller further is to simulate or calculate one or more of T1, T2, and T3.

In some examples, the controller further is to maintain T1 above the auto-ignition temperature of the fuel stream.

In some examples, the controller further is to maintain ΔT3 at less than about 20 20 C/min.

In some examples, the controller further is to maintain ΔT3 at less than about 10 °C/min.

In some examples, the controller further is to maintain ΔT3 at less than about 4 °C/min.

In some examples, the controller further is to maintain T1 at about 700-950 °C.

In some examples, the controller further is to maintain T1 at about 600-1200 °C.

In some examples, the system includes the controller further is to maintain T2 at less than about 600 °C.

In some examples, the controller further is to maintain T2 between 600 °C and 700 °C.

In some examples, the system includes a turboexpander of n stages wherein T2 is calculated between any of the n stages.

In some examples, the system includes an external motor to spin the turboexpander at a speed. In some examples, the external motor further overcomes losses in the turboexpander. In some examples, the second flow controller further increases m2 to reduce T2.

In some examples, when T3 equals T2, flow of m3 is brought to zero.

In some examples, the controller keeps T3 less than T2.

In some examples, m1, m2, and m3 are from a same source. As m1 increases, m2, m3, or both decrease. As m2 increases, m1, m3, or both decrease. As m3 increases, m1, m2, or both decrease.

In some examples, post-ignition, the combustor combusts the fuel stream with the oxidant stream in the presence of a portion of a recycle CO2 (reCO2) stream, and wherein, pre-ignition, the system further comprises an exothermic reactor to pre-heat the reCO2 stream, the oxidant stream, the product working fluid stream, or combinations thereof.

In some examples, the exothermic reactor is selected from the group consisting of a Sabatier reactor, a water-gas shift reactor, and a deoxygenation reactor.

In some examples, the exothermic reactor includes a deoxygenation reactor to burn a second fuel stream with a portion of the oxidant stream to produce a hot fluid stream and to inject the hot fluid stream into the oxidant stream.

In some examples, the exothermic reactor includes a Sabatier reactor, the Sabatier reactor to receive a portion of the reCO2 stream, the product working fluid stream comprising carbon dioxide, and to receive a hydrogen stream to produce a hot methane stream and to inject the hot methane stream into the reCO2 stream.

In some examples, the exothermic reactor includes a deoxygenation reactor to burn a second fuel stream with leftover oxygen from a portion of the second working fluid stream to produce a hot fluid stream and to inject the hot fluid stream into the second working fluid stream or to pass the hot fluid stream through the heat exchanger.

In some examples, the heat exchanger includes a plurality of heat exchangers in series and wherein the exothermic reactor comprises a deoxygenation reactor to burn a second fuel stream with leftover oxygen from a portion of the second working fluid stream withdrawn between a first of the plurality of heat exchangers and a last of the plurality of heat exchangers to produce a hot fluid stream and to inject the hot fluid stream into the second working fluid stream or to pass the hot fluid stream through one of the plurality of heat exchangers.

In another example, the present disclosure provides a system for handling transient conditions in an oxy-fuel combustion system. The system includes a fuel flow control device to vary a flow rate mF of a fuel stream. The system includes an oxygen flow control device to vary a flow rate mO of an oxygen fluid stream. The system includes a combustor to receive an oxidant stream and the fuel stream and to combust the fuel stream with the oxidant stream to produce a first working fluid at a temperature T1, wherein the oxidant stream consists of a product working fluid stream and the oxygen fluid stream. The system includes a turboexpander to receive the first working fluid stream and to produce work and a second working fluid stream at a temperature T2. The system includes a heat exchanger to receive the second working fluid stream and cool the second working fluid stream by indirect contact heat exchange against one or more coolant streams, one of the one or more coolant streams comprising the oxidant stream, and to produce the product working fluid stream. The system includes a first temperature detection device to measure the temperature T1 and to transmit the temperature T1 to a controller. The system includes a second temperature detection device to measure the temperature T2 and to transmit the temperature T2 to the controller. The system includes a third temperature detection device to measure a temperature T3 of the second working fluid stream at an entrance to the heat exchanger. The system includes a first flow control device to vary flow rate m1 of a first temperature control fluid stream into the combustor, wherein the first temperature control fluid stream is a first portion of the product working fluid stream and consists of one of the one or more coolant streams. The system includes a second flow control device to vary flow m2 of a second temperature control fluid stream into the turboexpander, wherein the first temperature control fluid stream is a second portion of the product working fluid stream and consists of one of the one or more coolant streams. The system includes a third flow control device to vary flow m3 of a third temperature control stream into the second working fluid stream upstream of the heat exchanger, wherein the third temperature control fluid stream is a third portion of the product working fluid stream. The system includes the controller to receive the temperature T1, the temperature T2, and the temperature T3, and to direct flow rates of the oxidant stream, the fuel stream, the first temperature control fluid stream, the second temperature control fluid stream, and the third temperature control fluid stream.

In some examples, the controller further is to calculate a rate of change of temperature T3, ΔT3, and keep ΔT3 below 4 °C/min by varying m1, m2, m3, mO, and/or mF within the constraints that T1 remains above 700 °C but below 950 °C and T2 remains less than 600 °C.

In some examples, the controller further is to calculate a rate of change of temperature T3, ΔT3, and keep ΔT3 below 10 °C/min by varying m1, m2, m3, mO, and/or mF within the constraints that T1 remains above 600 °C but below 1050 °C and T2 remains less than 700 °C.

In some examples, when T3 equals T2, flow of m3 is brought to zero.

In some examples, the disclosure provides a method for controlling temperature of a combustion system, the combustion system comprising a combustor combusting a fuel stream with an oxidant stream, producing a first working fluid at a temperature T1, a turboexpander using the first working fluid, generating work and a second working fluid stream at a temperature T2, and a heat exchanger receiving the second working fluid stream at a temperature T3 and cooling the second fluid working stream, generating a product working fluid stream. The method includes controlling a flow of a first temperature control stream (m1) to the combustor. The method includes controlling a flow of a second temperature control stream (m2) to the turboexpander. The method includes controlling a flow of a third temperature control stream (m3) to the heat exchanger. The method includes calculating a rate of change of T3 (ΔT3). The method includes controlling one or more of m1, m2, and m3 to: (i) maintain ΔT3 at a sufficiently low value to avoid damaging the heat exchanger, (ii) maintain T1 at a sufficiently high value to maintain flame in the combustor, and (iii) maintain T2 at a sufficiently low value to avoid damaging the turboexpander.

In some examples, the method includes controlling a flow of the fuel stream (mF) to the combustor. In some examples, the method includes controlling a flow of the oxidant stream (mO) to the combustor.

In some examples, the combustor is an oxy-fuel combustor.

In some examples, the method includes maintaining an equivalence ratio between the fuel stream and the oxidant stream in the combustor.

In some examples, the method includes controlling mF, mO, or both mF and mO, to maintain a flame temperature Tflame before mixing mF and mO with m1.

In some examples, at least two of the first temperature control stream, the second temperature control stream, and the third temperature control stream include portions of a coolant stream.

In some examples, the coolant stream is at a temperature of at most 300 °C, at most 400 °C, or at most 500 °C.

In some examples, the method includes cooling the second working fluid stream by indirect contact heat exchange against a coolant stream in the heat exchanger.

In some examples, the coolant stream is the product working fluid stream.

In some examples, the method includes cooling the second working fluid stream by indirect contact heat exchange against the oxidant stream in the heat exchanger.

In some examples, the method includes one or more of measuring T1 and transmitting T1 for use in calculating ΔT3; measuring T2 and transmitting T2 for use in calculating ΔT3; and measuring T3 and transmitting T3 for use in calculating ΔT3.

In some examples, the method includes simulating or calculating one or more of T1, T2, and T3.

In some examples, the method includes maintaining T1 above the fuel auto-ignition temperature.

In some examples, the method includes maintaining ΔT3 at less than about 20 °C/min.

In some examples, the method includes maintaining ΔT3 at less than about 10 °C/min.

In some examples, the method includes maintaining ΔT3 at less than about 4 °C/min.

In some examples, the method includes maintaining T1 at about 700-950 °C.

In some examples, the method includes maintaining T1 at about 600-1200 °C.

In some examples, the method includes maintaining T2 at less than about 600 °C.

In some examples, the method includes maintaining T2 between 600 °C and 700 °C.

In some examples, the method includes calculating T2 between any of n stages of a turboexpander.

In some examples, the method includes spinning the turboexpander at a speed by an external motor. In some examples, the method includes overcoming losses in the turboexpander by the external motor. In some examples, the method includes increasing m2 to reduce T2.

In some examples, when T3 equals T2, the method includes bringing flow of m3 to zero.

In some examples, the method includes keeping T3 less than T2.

In some examples, wherein m1, m2, and m3 are from a same source, and wherein the method includes increasing m1 decreases m2, m3, or both m2 and m3; increasing m2 decreases m1, m3, or both m1 and m3; and increasing m3 decreases m1, m2, or both m1 and m2.

In some examples, the disclosure provides a system for controlling a combustion system. The combustion system includes a combustor to combust a first fuel stream with an oxidant stream to produce a first working fluid stream, a turboexpander to use the first working fluid stream to generate work and a second working fluid stream, and a heat exchange system to receive the second working fluid and to cool the second working fluid stream to generate a product working fluid stream. The system includes a deoxygenation reactor to receive a portion of the second working fluid stream and a second fuel stream, the second fuel stream provided at a flow rate sufficient to react with oxygen in the second working fluid stream, resulting in a third working fluid stream. The heat exchange system receives the third working fluid stream and cools the third working fluid stream.

In some examples, the system includes an oxidant heat exchanger to heat the oxidant stream against the third working fluid stream.

In some examples, the heat exchange system includes a recycle CO2 heat exchanger to heat the oxidant stream against the third working fluid stream.

In some examples, the heat exchange system includes a first heat exchanger and a second heat exchanger in series. The portion of the second working fluid stream is drawn from between the first heat exchanger and the second heat exchanger and the third working fluid stream is passed to the second heat exchanger.

In some examples, the disclosure provides a system for controlling a combustion system. The combustion system includes a combustor to combust a fuel stream with an oxidant stream in the presence of a recycle CO2 (reCO2) stream to produce a first working fluid stream, a turboexpander to use the first working fluid stream to generate work and a second working fluid stream, and a heat exchange system to receive the second working fluid stream and to cool the second working fluid stream to generate a product working fluid stream. The system includes a Sabatier reactor to receive a portion of the reCO2 stream and a hydrogen stream to produce a hot methane stream, and to inject the hot methane stream into the reCO2 stream.

In some examples, the disclosure provides a system for controlling a combustion system. The combustion system includes a combustor to combust a fuel stream with an oxidant stream in the presence of a recycle CO2 (reCO2) stream to produce a first working fluid stream, a turboexpander to use the first working fluid stream to generate work and a second working fluid stream, and a heat exchange system to receive the second working fluid stream and to cool the second working fluid stream to generate a product working fluid stream. The system includes a Sabatier reactor to receive a portion of a secondary CO2 stream and a hydrogen stream to produce a hot methane stream, and to inject the hot methane stream into the secondary CO2 stream, wherein the secondary CO2 stream cools the turboexpander.

Further examples are provided in the drawings, detailed description, and claims.

### BRIEF DESCRIPTION OF DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a process flow diagram showing an example temperature-control system for controlling a combustion system.

FIG. 2 is a process flow diagram showing an example temperature-control system for controlling a combustion system.

FIG. 3 is a block diagram showing an example method for controlling a combustion system.

FIG. 4 is a block diagram showing an example method for controlling a combustion system.

FIG. 5 is a block diagram showing an example system for controlling a combustion system.

### DETAILED DESCRIPTION

The following description recites various aspects and embodiments of the inventions disclosed herein. No particular embodiment is intended to define the scope of the invention.

Rather, the embodiments provide non-limiting examples of various systems and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the word “to” with respect to an element encompasses “configured to” and “adapted to.”

As used herein, “about” means within ±10% of the stated value, e.g., within ±5% of the stated value, or within ±2% of the stated value.

The following paragraphs represent one example of the present invention and are not intended to represent all of the possible iterations possible. A recirculated Oxy-combustion cycle presents several unique challenges to achieve successful startup, shutdown, transient, and full capacity operations without damage to key components. High operational pressures require large casings and thicker materials, which must be slowly brought to full temperatures and pressures. Meanwhile, the complexity caused by various interacting controls requires practical tradeoffs to mitigate temperature rise while loading the facility quickly with stable flame. The interaction of both control and expensive components including but not limited to a combustor equipped with an igniter and supplied with oxidant, fuel, and recycle streams from the process, a turboexpander and associated secondary coolant interfaces from the process, pipework and manifolds, compressors and pumps, a system inventory controller, and a high pressure high temperature heat recuperator in communication must be achieved through coordinated control for the lifetime of the facility. Provisions may also be installed to allow for preheating of the facility to specific minimum temperatures.

The initial challenge occurs in combustion pre-ignition and ignition, wherein an ignition point must be selected with careful consideration of coupled equipment and controller interaction. In particular, a suitable ignition point is determined by (1) selecting the ignition pressure (2) determining the expected ignition window of the TEX at that pressure (in terms of temperature and flow of the key components) and (3) determining the suitable ignition fuel flowrate based on the anticipated delta T encountered through ignition process.

The detailed criteria for a stable ignition point must satisfy the following requirements: (1) Above a minimum required fuel flowrate to ensure sufficient pressure drop and controllability at both the low flow fuel and low flow oxidant controllers and at combustor nozzles. (2) Below a maximum fuel flowrate over which the resulting temperature change in the system at ignition is too high. (3) Satisfy the correct combustor bulk temperature to maintain flame (above auto-ignition, i.e., above 620 °C, in this example). (4) Satisfy the correct turbine exhaust temperature to avoid metallurgical concerns in the TEX (below 600 °C, in this example). (5) Reduce thermal shock/cycling to the heat exchanger as much as possible (ramp rate at or below 4 °C/min, or limit delta-T on ignition in some repeatable way, in this example). (6) Occur at a pressure below the maximum capability of the chosen ignitor system. (7) Occur at a low enough flow such that the TEX power does not immediately overcome the Load Commutated Invertor (LCI) load, disrupting speed control.

To do this, a system must utilize controllers on the recycle flow to combustor and secondary flow to turboexpander systems. The first controller serves to maintain recycle flow while applying additional flow to the secondary turboexpander system to moderate turboexpander temperatures. This decouples the combustor temperature from the turboexpander hot gas path expansion temperature, allowing the combustor to maintain higher temperature than the turboexpander can initially tolerate. Sufficient pressure to the quenching system is maintained by upstream compression.

A valve is used to modulate recycle flow to the combustor to maintain temperature above the minimum combustion temperature, while raising the overall firing temperature at a controlled rate. The valve can follow a schedule of flowrates, compensated using a calculated temperature for the bulk combustor outlet temperature.

Valves are coordinated on the secondary system to control the turboexpander outlet temperature or various stage temperatures or overall secondary flowrate at a desired secondary temperature.

A final combustor and turboexpander bypass valve directs quench flow from the cold, high pressure recycle to downstream of the turboexpander exhaust, mixing with the turboexpander exhaust before it enters the inlet of the heat recuperation system. It moderates temperature during startup by controlling quench flow to manage process temperature change across the recuperator at or below a maximum rate of allowable change (Degrees/min).

Once the pre-ignition permissives are met, fuel will be introduced to the combustor with the laser ignitor armed in continuous (or pulsing) operation.

Fuel at the ignition flowrate rate is admitted to the combustor in the presence of oxidant over a predetermined period (30 seconds, in this example). The actual period is limited by the system unburned hydrocarbon (UHC) limit, chosen to be significantly below the lower explosive limit (LEL) of methane.

The pressure conditions of the ignition point are near 20 bara, in this example. The maximum pressure is limited by the window of proven ignitor operation. This pressure is below that requiring the pumps. The temperature and pressure conditions pre-ignition will be dramatically different post ignition and create a step change that the plant must respond to. Once flame is detected, the startup process can proceed.

If ignition is not achieved within this period, controls shall cut fuel and disarm the ignitor until unburned hydrocarbons, UHCs, or carbon monoxide monitors read below predetermined thresholds with significant margin from lower explosive limits (LELs) for each given contaminant. The facility will not shut down in the event of a failed ignition at this stage. Instead, once the minimum thresholds are achieved (given the continuous CO2 added to the system at this point), the ignition sequence will recommence.

Once ignition is achieved and stable flame ensured, fuel is held momentarily to conduct necessary checks. Temperatures and pressures will quickly rise. Agreement must be made on the temperature profile to achieve at TEX following initial ignition delta T to begin fuel rise. Depending on the ignition point, it may be necessary to move quickly from the ignition point to one at higher flowrate to stabilize plant and the HXR and TEX without overtemperature. These details should be evaluated in final ignition window down-selection.

Once flowrates and temperatures have stabilized within the accepted margins, the facility can proceed into the post-ignition phase.

In post-ignition, the priority goal is to maintain flame while ensuring the plant is stable. The TEX is still motored by the generator VFD, and most equipment has not yet come online. At this point, the plant will begin loading along its fuel loading curve.

Because of heat generation from combustion, the HGC and ASU HTF may be diverted from the HXR at this time.

During post-ignition, the secondary flow ratio will be maintained significantly above normal ratios to ensure the turboexpander outlet temperature remains below a target maximum temperature. Without this, the combustion temperature would drop below the desired level, leading to unreliable ignition and instabilities.

The plant will begin ramping fuel at the fuel schedule. Oxidant and recycle will ramp accordingly to maintain combustor temperature. During this period, secondary control will be in effect, driving secondary flow above the normal flow rate.

As the plant loads, the flowrates dictated by the temperature controls will allow secondary flow to equalize to its design flow ratio. Once this occurs, the recycle flow controller will switch to turboexpander outlet temperature control, controlling TOT to remain at design temp (approximately 590 °C, in this example).

In summary, during the lead up to ignition, the secondary flow will be increased above its normal operational range. Shortly after ignition it will reach its stable ratio as the turboexpander loads and produces power with the controller disengaging.

The startup bypass control concept will meanwhile moderate temperature at the HXR inlet. The HXR inlet temperature will ramp at 4 °C per minute (in this example) with the RCO2, Oxidant, and 2NDCO2 streams ramping temperature to their full load temperature values. It is anticipated these trends will NOT be perfectly linear but will ramp non-linearly and/or be pinched to the HXR inlet temperature. In any case, the process temperatures will ramp at rates below the HXR inlet temperature of 4 °C/min, in this example.

After the 2NDCO2 ratio controller unloads, the plant will continue ramping along at 4 °C per minute (in this example) and along the fuel schedule as the VFD continues to unload.

TOP Increase: a few minutes following ignition, the plant will begin its move from a TOP of 20 bara to its design pressure of 40.7 bara (in this example). This will continue through the next several stages. This allows for full discharge pressure to be achieved at the compressors. The timing and sequence of the rise in TOP pressure will depend on plant volume, inventory build-up rate, and specific operability requirements.

2NDCO2 Ratio Control Normalization: The 2NDCO2 enters at higher pressure than the RCO2, and then falls back under the RCO2 pressure at approximately 10 minutes, the time at which the 2NDCO2 ratio controller normalizes.

Pressure Ratio @ TEX: The TEX provides very low pressure ratio (close to 1) during initial startup, and then continues to build pressure ratio as flowrates increase, in this example.

As the TOP increases, the load on the RCC will increase.

As the plant begins to load, and the TEX begin to overcome its losses, the VFD will continue to unload. At the point where the VFD unloads, the plant can either begin synchronization or begin loading without the VFD. As fuel flow increases the TEX driveline continues to produce power, overcoming the VFD. Once the TEX gross power equals the TEX driveline output, the VFD is fully unloaded, any final synchronization steps can be completed, and load up fully on turboexpander power can commence.

Following the above steps, the primary plant control loops will move to PV and CV values that will remain consistent throughout the remainder of the loading period. Design turboexpander outlet pressure has been achieved. Changes in setpoints and the staging of equipment will now drive the majority of the sequence. The Startup Bypass temperature controller will remain in control until full temperature has been achieved while abiding to the rate limitation set above.

Following Step 3: Synchronization (VFD Unloading), the goal of the facility is to achieve design temperatures across the facility, driven by achieving the correct TEX TOT and resulting HXR hot end inlet temperature. At this point, the turboexpander bypass shall close.

The Loading to FSFL phase is the final part of the sequence after achieving Fixed TOT control as the plant increases flowrates.

The loading phase is performed at constant TOT. TIT will continue to increase at this time. As governor setpoint is increased with TOT held constant, the plant will ramp inlet temperature, pressure and mass flow conditions at the inlet of the TEX as determined by the plant design and turbine flow function. Since constant TOT is achieved well before plant auxiliary power matches TEX power, the partial load points are all achievable at constant TOT, allowing for maximum turndown and ramp rate across the operational profile.

The same methodology can be applied to the transient and shutdown operation of the facility. As key components need to be unloaded and cooled to lower temperature while still maintaining stable operation, the series of recycle flow, secondary flow, and bypass controllers can act to maintain respective temperature limits and ramp rates within acceptable margins.

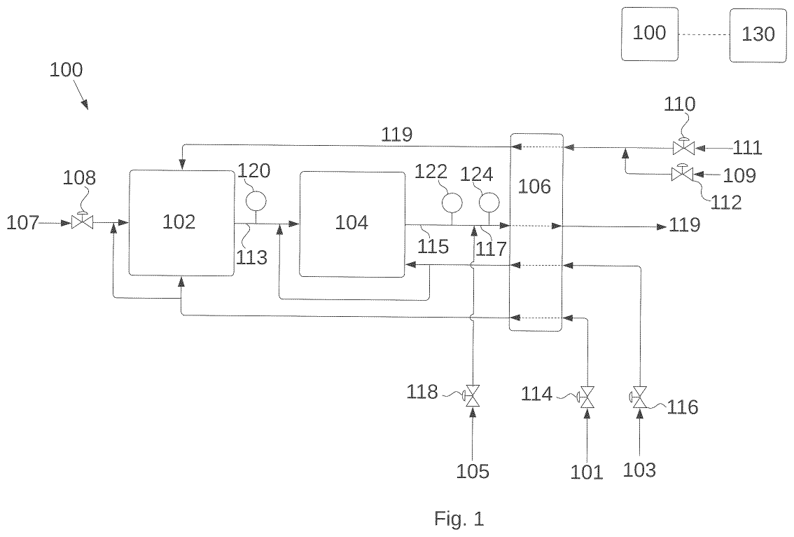

Now referring to FIG. 1, FIG. 1 is a process flow diagram showing an example temperature-control system for controlling a combustion system that may be used in some examples provided herein. This example is purely illustrative, and multiple other examples are envisioned or may be readily envisioned without undue experimentation.

In some examples, system 100 is an oxy-fuel combustion system for generating power. In the nonlimiting configuration in FIG. 1, system 100 includes a combustor 102, a turboexpander 104, a heat exchanger 106, a fuel control valve 108, an oxygen control valve 112, a first working fluid valve 114, a second working fluid valve 116, a third working fluid valve 118, a fourth working fluid valve 110, a first temperature element 120, a second temperature element 122, a third temperature element 124, and a controller 130. The turboexpander may be one, two, or n stages. The heat exchanger may be one, two, or m stages.

Controller 130 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 130 and the system 100 may be implemented using any suitable combination of hardware and software.

Fuel flow controller 108 controls fuel stream 107 into the combustor 102. Oxygen flow controller 112 controls oxygen stream 109 while fourth working fluid valve 110 controls working fluid 111. Streams 109 and 111 combine to form oxidant stream 119, which passes through heat exchanger 106 to be preheated and then to combustor 102. First working fluid valve 114 controls working fluid stream 101 through preheating in exchanger 106 and on to either directly inject into combustor 102 or to combine with stream 107 before injection into the combustor. Second working fluid valve 116 controls working stream 103 through preheating in exchanger 106 and on to either directly inject into turboexpander 104 or to combine with stream 113 before passage into the turboexpander. Third working fluid valve 118 controls working fluid stream 105 to combine with stream 115 before heat exchanger 106.

The injection points for streams 101, 103, and 105 can vary depending on the final configuration of the equipment. As noted, stream 101 can be injected into the combustor or before. How much before depends on the mixing required. Stream 103 can be injected before the first turboexpander, or between stages in instances where the turboexpander has 1, 2, or even n stages. Stream 105 may be injected into the heat exchanger, before the heat exchanger, or directly after the turboexpander, depending on mixing requirements. In the cases of multiple heat exchangers, stream 105 may also be injected in part before the first heat exchanger, and further amounts between stages.

Fuel combusted in combustor 102 passes as working fluid stream 113 into turboexpander 104 at a temperature T1, as measured by temperature element 120. Hot working fluid 115 leaves the turboexpander at temperature T2, as measured by temperature element 120, and is cooled first by contact with working fluid 105 to reach temperature T3, as measured by temperature element 124, and then through exchanger 106, producing a cooled working fluid 119. In this example, the cooled working fluid is passed through the balance of the oxy-fuel combustion system where it is reconstituted to form streams 101, 103, 105, and 111. Other examples include non-oxy-fuel combustion systems.

The controller obtains T1, T2, and T3 from temperature elements 120, 122, and 124. These elements are either physical instruments or virtual instruments simulated or calculated by other measurements using machine learning or similar methods. With T1, T2, and T3 in hand, the controller 130 calculates a rate of change of T3, ΔT3. The controller then controls one or more of flows 101, 103, and 105 to maintain ΔT3 at a sufficiently low value to avoid damaging the heat exchanger 106; to maintain T1 at a sufficiently high value to maintain flame in the combustor 102; and to maintain T2 at a sufficiently low value to avoid damaging the turboexpander 104.

In some examples, the controller further controls the flows of 107 and 119 to maintain the same three items as in the previous paragraph. In some examples, the fuel flow 107 and oxygen flow 109 are controlled to maintain an equivalence ration between the two streams in the combustor. In some examples, the controller 130 maintains T1 above the fuel auto-ignition temperature.

In some examples, the working fluids 111, 101, 103, and 105 consist of carbon dioxide produced by the combustion process. In some examples, these streams are kept at a temperature of at most 300 °C. In some examples, these streams are kept at a temperature of at most 400 °C. In some examples, these streams are kept at a temperature of at most 500 °C.

In some examples, avoiding damaging the heat exchanger 106 requires maintaining ΔT3 at less than about 20 °C/min. In some examples, avoiding damaging the heat exchanger 106 requires maintaining ΔT3 at less than about 10 °C/min. In some examples, avoiding damaging the heat exchanger 106 requires maintaining ΔT3 at less than about 4 °C/min.

In some examples, the controller 130 maintains T1 at about 700 to 950 °C. In some examples, the controller 130 maintains T1 at about 600 to 120 °C.

In some examples, to avoid damaging the turboexpander 104, the controller 130 maintains T2 at less than about 550 °C. In some examples, to avoid damaging the turboexpander 104, the controller 130 maintains T2 at less than about 600 °C. In some examples, to avoid damaging the turboexpander 104, the controller 130 maintains T2 at less than about 700 °C.

In some examples, at a minimum load or plant initialization where there is insufficient fluid power, the turboexpander spins at a minimum speed induced by an external motor. The external power provided by the motor must overcome losses in the expander, which increase with speed and include ventilation and pumping losses within the turboexpander. These losses increase the effective T2 and require additional m2 to compensate. In some examples, lowering speed below the turboexpander full speed design requirement reduces losses and the effective T2, reducing m2 requirements. When the turboexpander is brought to full speed and when the fluid power increases to overcome the losses, the external motor power is no longer required, and the turboexpander begins to produce power based on its performance curve. In these examples, T2 can be predicted based upon the conditions entering the turboexpander at T1.

In some examples, when T3 equals T2, the controller 130 brings the third working fluid flow to zero.

In some examples, the first, second, and third working fluids are from a common source. As one increases, one or both of the others must decrease.

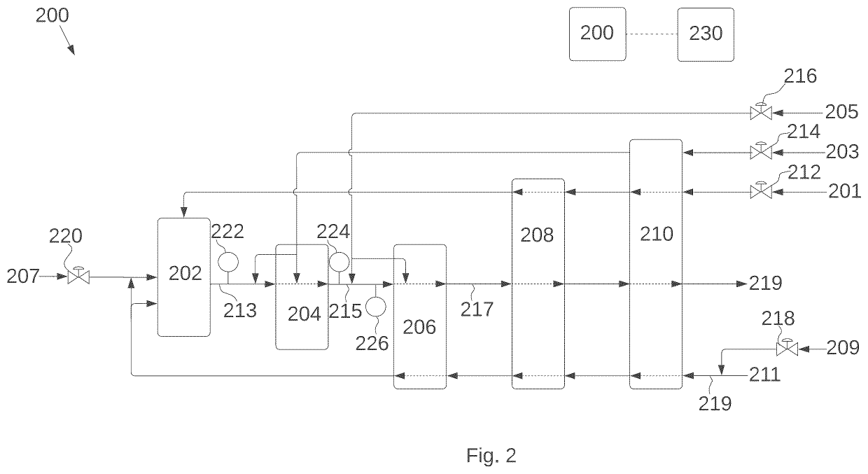

Now referring to FIG. 2, FIG. 2 is a process flow diagram showing an example temperature-control system for controlling a combustion system that may be used in some examples provided herein. This example is purely illustrative, and multiple other examples are envisioned or may be readily envisioned without undue experimentation.

In some examples, system 200 is an oxy-fuel combustion system for generating power. In the nonlimiting configuration in FIG. 2, system 200 includes a combustor 202, a turboexpander 204, a first heat exchanger 206, a second heat exchanger 208, a third heat exchanger 210, a fuel control valve 220, an oxygen control valve 218, a first working fluid valve 212, a second working fluid valve 214, a third working fluid valve 216, a first temperature element 222, a second temperature element 224, a third temperature element 226, and a controller 230. The turboexpander may be one, two, or n stages.

Controller 230 may include any suitable combination of hardware (e.g., application specific integrated circuit (ASIC), field programmable gate array (FPGA), central processing unit (CPU), graphics process unit (GPU) or the like) and software (e.g., instructions causing the hardware to implement the functionality described herein). The instructions may be stored on a non-transitory computer-readable medium storing instructions to cause the processor to perform the steps of the present system. The circuitry between the controller 230 and the system 200 may be implemented using any suitable combination of hardware and software.

Fuel flow controller 220 controls fuel stream 207 into the combustor 202. Oxygen flow controller 218 controls oxygen stream 209 to combine with working fluid stream 211. Streams 209 and 211 combine to form oxidant stream 219, which passes through heat exchangers 210, 208, and 206 to be preheated and then pass to combustor 202. First working fluid valve 214 controls working fluid stream 201 through preheating in exchanger 210 and 208 and on to either directly inject into combustor 202 or to combine with stream 207 before injection into the combustor. Second working fluid valve 214 controls working stream 203 through preheating in exchanger 210 and on to either directly inject into turboexpander 204 or to combine with stream 213 before passage into the turboexpander. Third working fluid valve 216 controls working fluid stream 205 to combine with stream 215 before heat exchanger 206.

The injection points for streams 201, 203, and 205 can vary depending on the final configuration of the equipment. As noted, stream 201 can be injected into the combustor or before. How much before depends on the mixing required. Stream 203 can be injected before the first turboexpander, or between stages in instances where the turboexpander has 1, 2, or even n stages. Stream 105 may be injected into the heat exchanger 206, before the heat exchanger 206, or directly after the turboexpander, depending on mixing requirements. In this case of multiple heat exchangers, stream 205 may also be injected in part before exchanger 206, and further amounts between stages 208 and 210.

Fuel combusted in combustor 202 passes as working fluid stream 213 into turboexpander 204 at a temperature T1, as measured by temperature element 222. Hot working fluid 215 leaves the turboexpander at temperature T2, as measured by temperature element 224, and is cooled first by contact with working fluid 205 to reach temperature T3, as measured by temperature element 226, and then through exchangers 206, 208, and 210, producing a cooled working fluid 219. In this example, the cooled working fluid is passed through the balance of the oxy-fuel combustion system where it is reconstituted to form streams 201, 203, 205, and 211. Other examples include non-oxy-fuel combustion systems.

The controller obtains T1, T2, and T3 from temperature elements 222, 224, and 226. These elements are either physical instruments or virtual instruments simulated or calculated by other measurements using machine learning or similar methods. With T1, T2, and T3 in hand, the controller 230 calculates a rate of change of T3, ΔT3. The controller then controls one or more of flows 201, 203, and 205 to maintain ΔT3 at a sufficiently low value to avoid damaging the heat exchangers 206, 208, and 210; to maintain T1 at a sufficiently high value to maintain flame in the combustor 202; and to maintain T2 at a sufficiently low value to avoid damaging the turboexpander 204.

In some examples, the working fluids 211, 201, 203, and 205 consist of carbon dioxide produced by the combustion process. In some examples, these streams are kept at a temperature of at most 300 °C. In some examples, these streams are kept at a temperature of at most 400 °C. In some examples, these streams are kept at a temperature of at most 500 °C.

In some examples, avoiding damaging the heat exchanger 206, 208, and 210 requires maintaining ΔT3 at less than about 20 °C/min. In some examples, avoiding damaging the heat exchangers requires maintaining ΔT3 at less than about 10 °C/min. In some examples, avoiding damaging the heat exchangers requires maintaining ΔT3 at less than about 4 °C/min.

In some examples, the controller 230 maintains T1 at about 700 to 950 °C. In some examples, the controller 130 maintains T1 at about 600 to 120 °C.

In some examples, to avoid damaging the turboexpander 204, the controller 230 maintains T2 at less than about 600 °C. In some examples, to avoid damaging the turboexpander 204, the controller 230 maintains T2 at less than about 700 °C.

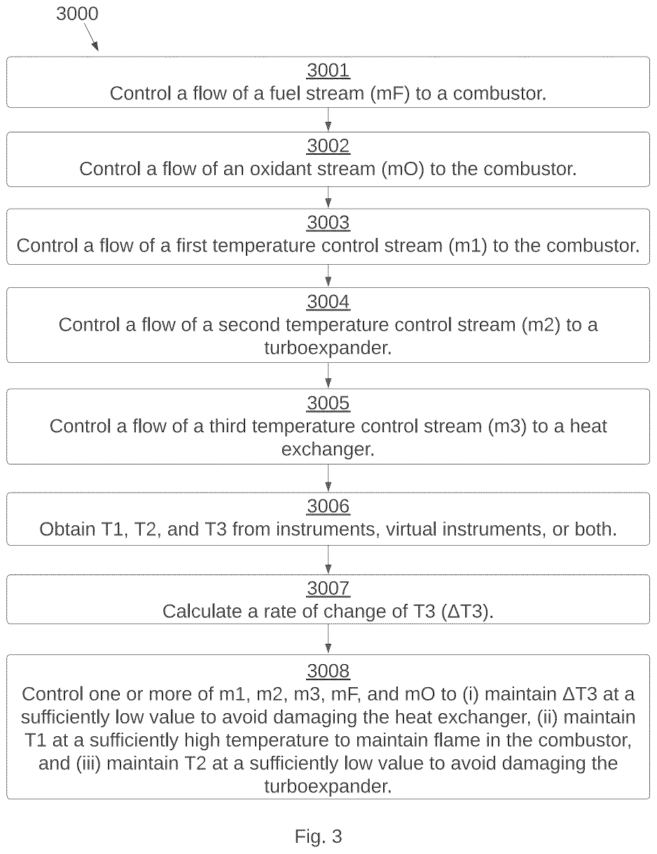

Now referring to FIG. 3, FIG. 3 is a block diagram showing an example method for controlling a combustion system that may be used in some examples provided herein. The method controls temperatures of a combustion system. While method 3000 optionally may be implemented using system 100 or 200, it will be appreciated that any other suitable combination of components may be used to implement method 3000.

Method 3000 illustrated in FIG. 3 may include controlling a flow of a fuel stream (mF) to a combustor (operation 3001). For example, in a manner such as described above with reference to FIG. 1, controller 130 may control fuel stream 107 by controlling fuel control valve 108.

Referring again to FIG. 3, method 3000 may also include controlling a flow of an oxidant stream (mO) to the combustor (operation 3002). For example, in a manner such as described above with reference to FIG. 1, controller 130 may control oxygen stream 109 and working fluid stream 111 (combined as oxidant stream 119) by controlling oxygen control valve 112 and fourth working fluid valve 110.

Referring again to FIG. 3, method 3000 may also include controlling a flow of a first temperature control stream (m1) to the combustor (operation 3003). For example, in a manner such as described above with reference to FIG. 1, controller 130 may control working fluid stream 101 by controlling first working fluid control valve 114.

Referring again to FIG. 3, method 3000 may also include controlling a flow of a second temperature control stream (m2) to the turboexpander (operation 3004). For example, in a manner such as described above with reference to FIG. 1, controller 130 may control working fluid stream 103 by controlling second working fluid control valve 116.

Referring again to FIG. 3, method 3000 may also include controlling a flow of a third temperature control stream (m3) to the heat exchanger (operation 3005). For example, in a manner such as described above with reference to FIG. 1, controller 130 may control working fluid stream 105 by controlling third working fluid control valve 118.

Referring again to FIG. 3, method 3000 may also include obtaining T1, T2, and T3 from instruments, virtual instruments, or both (operation 3006). For example, in a manner such as described above with reference to FIG. 1, temperature elements 120, 122, and 124, which may be physical instruments or virtual instruments, or both, send signals to controller 130.

Referring again to FIG. 3, method 3000 may also include calculating a rate of change of T3 (ΔT3) (operation 3007). For example, in a manner such as described above with reference to FIG. 1, controller 130 may calculate ΔT3.

Referring again to FIG. 3, method 3000 may also include controlling one or more of m1, m2, m3, mF, and mO to (i) maintain ΔT3 at a sufficiently low value to avoid damaging the heat exchanger, (ii) maintain T1 at a sufficiently high value to maintain flame in the combustor, and (iii) maintain T2 at a sufficiently low value to avoid damaging the turboexpander (operation 3008). For example, in a manner such as described above with reference to FIG. 1, controller 130 controls valves 114, 116, 118, 108, 110, and 112 to maintain the three variables.

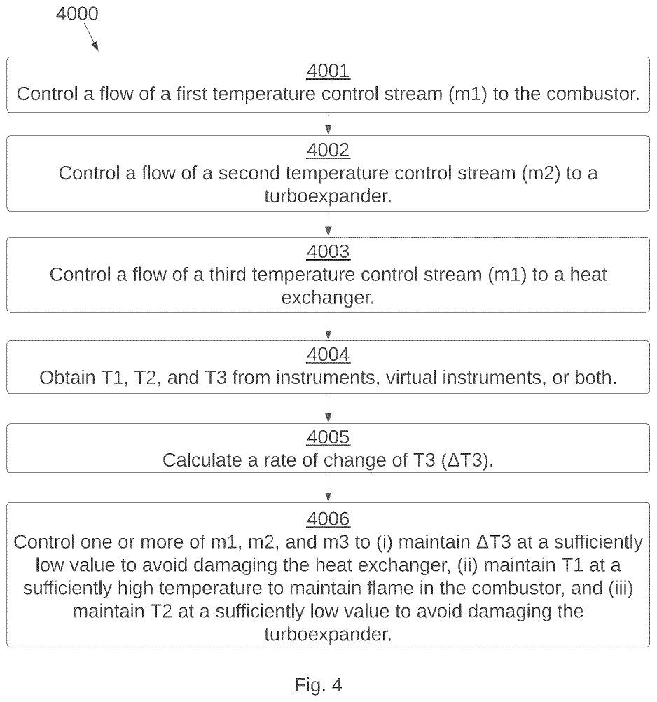

Now referring to FIG. 4, FIG. 4 is a block diagram showing an example method for controlling a combustion system that may be used in some examples provided herein. The method controls temperatures of a combustion system. While method 4000 optionally may be implemented using system 100 or 200, it will be appreciated that any other suitable combination of components may be used to implement method 4000.

Referring again to FIG. 4, method 4000 may also include controlling a flow of a first temperature control stream (m1) to the combustor (operation 4001). For example, in a manner such as described above with reference to FIG. 1, controller 130 may control working fluid stream 101 by controlling first working fluid control valve 114.

Referring again to FIG. 4, method 4000 may also include controlling a flow of a second temperature control stream (m2) to the turboexpander (operation 4002). For example, in a manner such as described above with reference to FIG. 1, controller 130 may control working fluid stream 103 by controlling second working fluid control valve 116.

Referring again to FIG. 4, method 4000 may also include controlling a flow of a third temperature control stream (m3) to the heat exchanger (operation 4003). For example, in a manner such as described above with reference to FIG. 1, controller 130 may control working fluid stream 105 by controlling third working fluid control valve 118.

Referring again to FIG. 4, method 4000 may also include obtaining T1, T2, and T3 from instruments, virtual instruments, or both (operation 4004). For example, in a manner such as described above with reference to FIG. 1, temperature elements 120, 122, and 124, which may be physical instruments or virtual instruments, or both, send signals to controller 130.

Referring again to FIG. 4, method 4000 may also include calculating a rate of change of T3 (ΔT3) (operation 4005). For example, in a manner such as described above with reference to FIG. 1, controller 130 may calculate ΔT3.

Referring again to FIG. 4, method 4000 may also include controlling one or more of m1, m2, and m3, to (i) maintain ΔT3 at a sufficiently low value to avoid damaging the heat exchanger, (ii) maintain T1 at a sufficiently high value to maintain flame in the combustor, and (iii) maintain T2 at a sufficiently low value to avoid damaging the turboexpander (operation 4006). For example, in a manner such as described above with reference to FIG. 1, controller 130 controls valves 114, 116, and 118, to maintain the three variables.

A Sabatier reactor is added to the oxy-fuel combustion system as detailed below in order to create heat during startup and as needed in upset conditions. A deoxygenation reactor is added to the oxy-fuel combustion system as detailed below in order to create heat and remove excess oxygen as needed during startup and during operations.

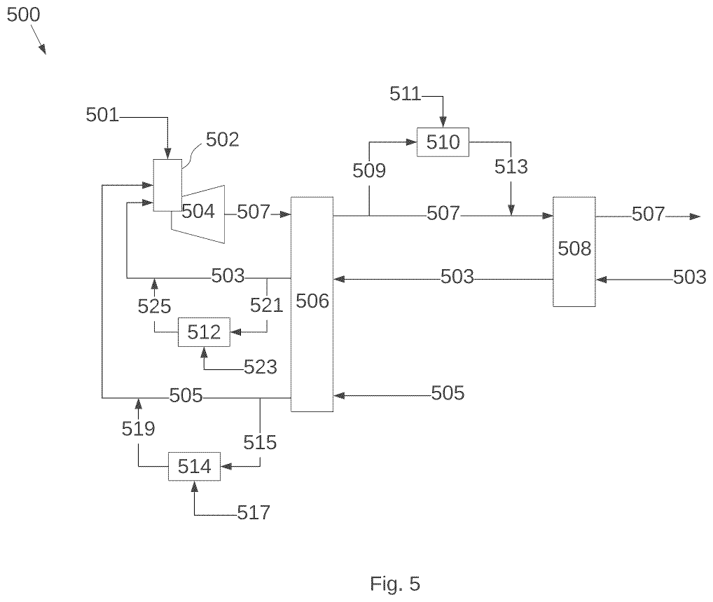

FIG. 5 is a process flow diagram showing an example system for controlling a combustion system that may be used in some examples provided herein. This example is purely illustrative, and multiple other examples are envisioned or may be readily envisioned without undue experimentation. Fuel 501 and oxidant 505 are combusted in the presence of recycle CO2 503 in combustor 502, passing a working fluid to turboexpander 504 which drives turboexpander 504, and passing working fluid 507 to the first heat exchanger 506 and on to second heat exchanger 508. Working fluid 507 heats oxidant 505 and recycle CO2 503 in heat exchangers 506 and 508.

Sabatier reactor 512 receives a slip stream 521 of recycle CO2 503 and a hydrogen stream 523. The reaction of a part of the CO2 and the hydrogen in reactor 512 produces heat and fuel and returns the stream 525 to recombine with recycle CO2 503.

Deoxygenation reactor 510 receives a slip stream 509 from working fluid stream 507 and a fuel stream 511. The fuel stream 511 is combusted with the excess oxygen in working fluid slip stream 509, producing heat and reducing the oxygen in the returning stream 513.

Deoxygenation reactor 514 receives a slip stream 515 from oxidant stream 505 and a fuel stream 517. The fuel stream 517 is combusted with oxygen in oxidant slip stream 515, producing heat in the returning stream 519.

In some examples, system 500 is an oxy-fuel combustion system for generating power. In the nonlimiting configuration in FIG. 5, system 500 includes a combustor 502, a turboexpander 504, a first heat exchanger 506, a second heat exchanger 508, a first deoxygenation reactor 510, a Sabatier reactor 512, and a second deoxygenation 514.

In some examples, post-ignition, the combustor 502 combusts the fuel stream 501 with the oxidant stream 505 in the presence of a portion of a recycle CO2 (reCO2) stream 503, and wherein, pre-ignition, the system further comprises an exothermic reactor (such as 510, 512, and 514) to pre-heat the reCO2 stream 503, the oxidant stream 505, the product working fluid stream 507, or combinations thereof.

In some examples, the exothermic reactor (510, 512, 514) is selected from the group consisting of a Sabatier reactor, a water-gas shift reactor, and a deoxygenation reactor.

In some examples, the exothermic reactor (510, 512, 514) includes a deoxygenation reactor 514 to burn a second fuel stream 517 with a portion of the oxidant stream 515 to produce a hot fluid stream 519 and to inject the hot fluid stream 519 into the oxidant stream 505.

In some examples, the exothermic reactor includes a Sabatier reactor 512, the Sabatier reactor 512 to receive a portion of the reCO2 stream 503, the product working fluid stream comprising carbon dioxide, and to receive a hydrogen stream 512 to produce a hot methane stream 525 and to inject the hot methane stream 525 into the reCO2 stream 503.

In some examples, the exothermic reactor includes a deoxygenation reactor 510 to burn a second fuel stream 511 with leftover oxygen from a portion of the second working fluid stream 509 to produce a hot fluid stream 513 and to inject the hot fluid stream 513 into the second working fluid stream 507 or to pass the hot fluid stream through the heat exchanger.

In some examples, the heat exchanger includes a plurality of heat exchangers in series (such as 506 and 508) and wherein the exothermic reactor comprises a deoxygenation reactor 510 to burn a second fuel stream 511 with leftover oxygen from a portion of the second working fluid stream 509 withdrawn between a first of the plurality of heat exchangers 506 and a last of the plurality of heat exchangers 508 to produce a hot fluid stream 513 and to inject the hot fluid stream 513 into the second working fluid stream 507 or to pass the hot fluid stream through one of the plurality of heat exchangers.

In some examples, the disclosure provides a system for controlling a combustion system. The combustion system includes a combustor 502 to combust a first fuel stream 501 with an oxidant stream 505 to produce a first working fluid stream, a turboexpander 504 to use the first working fluid stream to generate work and a second working fluid stream 507, and a heat exchange system 506 and 508 to receive the second working fluid 507 and to cool the second working fluid stream 507 to generate a product working fluid stream 507/503. The system includes a deoxygenation reactor 510 to receive a portion of the second working fluid stream 509 and a second fuel stream 511, the second fuel stream 511 provided at a flow rate sufficient to react with oxygen in the second working fluid stream 509, resulting in a third working fluid stream 513. The heat exchange system receives the third working fluid stream 513 and cools the third working fluid stream 513.

In some examples, the system includes an oxidant heat exchanger to heat the oxidant stream against the third working fluid stream.

In some examples, the heat exchange system includes a recycle CO2 heat exchanger to heat the oxidant stream against the third working fluid stream.

In some examples, the heat exchange system includes a first heat exchanger and a second heat exchanger in series (506 and 508). The portion of the second working fluid stream 509 is drawn from between the first heat exchanger 506 and the second heat exchanger 508 and the third working fluid stream 513 is passed to the second heat exchanger.

In some examples, the disclosure provides a system for controlling a combustion system. The combustion system includes a combustor 502 to combust a fuel stream 501 with an oxidant stream 505 in the presence of a recycle CO2 (reCO2) stream 503 to produce a first working fluid stream, a turboexpander to use the first working fluid stream to generate work and a second working fluid stream 507, and a heat exchange system 506 and 508 to receive the second working fluid stream 507 and to cool the second working fluid stream 507 to generate a product working fluid stream 507/503. The system includes a Sabatier reactor 512 to receive a portion of the reCO2 stream 521 and a hydrogen stream 523 to produce a hot methane stream 525, and to inject the hot methane stream 525 into the reCO2 stream 503.

In some examples, the disclosure provides a system for controlling a combustion system. The combustion system includes a combustor 502 to combust a fuel stream 501 with an oxidant stream 505 in the presence of a recycle CO2 (reCO2) stream 503 to produce a first working fluid stream, a turboexpander 504 to use the first working fluid stream to generate work and a second working fluid stream 507, and a heat exchange system 506 and 508 to receive the second working fluid stream 507 and to cool the second working fluid stream 507 to generate a product working fluid stream 507/503. The system includes a Sabatier reactor to receive a portion of a secondary CO2 stream and a hydrogen stream to produce a hot methane stream, and to inject the hot methane stream into the secondary CO2 stream, wherein the secondary CO2 stream cools the turboexpander.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A temperature-control system for controlling a combustion system, the combustion system comprising a combustor to combust a fuel stream with an oxidant stream to produce a first working fluid stream at a temperature T1, a turboexpander to use the first working fluid stream to generate work and a second working fluid stream at a temperature T2, and a heat exchanger to receive the second working fluid stream at a temperature T3 and to cool the second fluid working stream to generate a product working fluid stream, the temperature-control system comprising:
a first flow controller to control a flow of a first temperature control stream (m1) to the combustor;
a second flow controller to control a flow of a second temperature control stream (m2) to the turboexpander;
a third flow controller to control a flow of a third temperature control stream (m3) to the heat exchanger; and
a controller to:
calculate a rate of change of T3 (ΔT3); and
control one or more of m1, m2, and m3 to: (i) maintain a change in T3 (ΔT3) at a sufficiently low value to avoid damaging the heat exchanger, (ii) maintain T1 at a sufficiently high value to maintain flame in the combustor, and (iii) maintain T2 at a sufficiently low value to avoid damaging the turboexpander.

2. The temperature-control system of claim 1, further comprising a fuel flow controller to control a flow of the fuel stream (mF) to the combustor.

3. The temperature-control system of claim 2, wherein further comprising using an oxygen flow controller to control a flow of the oxidant stream (mO) to the combustor.

4. The temperature-control system of claim 3, wherein the combustor comprises an oxy-fuel combustor.

5. The temperature-control system of claim 3, wherein the controller further is to control one or more of the fuel flow controller and oxygen flow controller so as to maintain an equivalence ratio between the fuel stream and the oxidant stream in the combustor.

6. The temperature-control system of claim 3, wherein the controller further is to control mF, mO, or both mF and mO, to maintain a flame temperature Tflame before mixing mF and mO with m1.

7. The temperature-control system of claim 1, wherein at least two of the first temperature control stream, the second temperature control stream, and the third temperature control stream comprise portions of a coolant stream.

8. The temperature-control system of claim 7, wherein the coolant stream is at a temperature of at most 300 °C.

9. The temperature-control system of claim 7, wherein the coolant stream is at a temperature of at most 400 °C.

10. The temperature-control system of claim 7, wherein the coolant stream is at a temperature of at most 500 °C.

11. The temperature-control system of claim 1, the heat exchanger further to cool the second working fluid stream by indirect contact heat exchange against a coolant stream.

12. The temperature-control system of claim 11, wherein the coolant stream comprises the product working fluid stream.

13. The temperature-control system of claim 1, the heat exchanger further to cool the second working fluid stream by indirect contact heat exchange against the oxidant stream.

14. The temperature-control system of claim 1, further comprising one or more of:
a first sensor to measure T1 and transmit T1 to the controller;
a second sensor to measure T2 and transmit T2 to the controller; and
a third sensor to measure T3 and transmit T3 to the controller.

15. The temperature-control system of claim 1, wherein the controller further is to simulate or calculate one or more of T1, T2, and T3.

16. The temperature-control system of claim 1, wherein the controller further is to maintain T1 above an auto-ignition temperature of the fuel stream.

17. The temperature-control system of claim 1, wherein the controller further is to maintain ΔT3 at less than about 20 °C/min.

18. The temperature-control system of claim 1, wherein the controller further is to maintain ΔT3 at less than about 10 °C/min.

19. The temperature-control system of claim 1, wherein the controller further is to maintain ΔT3 at less than about 4 °C/min.

20. The temperature-control system of claim 1, wherein the controller further is to maintain T1 at about 700-950 °C.

21. The temperature-control system of claim 1, wherein the controller further is to maintain T1 at about 600-1200 °C.

22. The temperature-control system of claim 1, wherein the controller further is to maintain T2 at less than about 600 °C.

23. The temperature-control system of claim 1, wherein the controller further is to maintain T2 between 600 °C and 700 °C.

24. The temperature-control system of claim 1, wherein the turboexpander comprises n stages, and wherein T2 is calculated between any of the n stages.

25. The temperature-control system of claim 1, further comprising an external motor to spin the turboexpander at a speed.

26. The temperature-control system of claim 25, the external motor further to overcome losses in the turboexpander.

27. The temperature-control system of claim 26, the second flow controller further to increase m2 to reduce T2.

28. The temperature-control system of claim 1, wherein the controller further is to bring m3 to zero when T3 equals T2.

29. The temperature-control system of claim 1, wherein the controller further is to keep T3 less than T2.

30. The temperature-control system of claim 1, wherein m1, m2, and m3 are from a same source as one another.

31. The temperature-control system of claim 1, wherein as m1 increases, m2, m3, or both m2 and m3 decrease.

32. The temperature-control system of claim 1, wherein as m2 increases, m1, m3, or both m1 and m3 decrease.

33. The temperature-control system of claim 1, wherein as m3 increases, m1, m2, or both m1 and m2 decrease.

34. The temperature-control system of claim 1, wherein, post-ignition, the combustor combusts the fuel stream with the oxidant stream in the presence of a portion of a recycle CO2 (reCO2) stream, and wherein, pre-ignition, the temperature-control system further comprises an exothermic reactor to pre-heat the reCO2 stream, the oxidant stream, the product working fluid stream, or combinations thereof.

35. The temperature-control system of claim 34, wherein the exothermic reactor is selected from the group consisting of a Sabatier reactor, a water-gas shift reactor, and a deoxygenation reactor.

36. The temperature-control system of claim 34, wherein the exothermic reactor comprises a deoxygenation reactor to burn a second fuel stream with a portion of the oxidant stream to produce a hot fluid stream and to inject the hot fluid stream into the oxidant stream.

37. The temperature-control system of claim 34, wherein the exothermic reactor comprises a Sabatier reactor, the Sabatier reactor to receive a portion of the reCO2 stream, the product working fluid stream comprising carbon dioxide, and to receive a hydrogen stream to produce a hot methane stream and to inject the hot methane stream into the reCO2 stream.

38. The temperature-control system of claim 34, wherein the exothermic reactor comprises a deoxygenation reactor to burn a second fuel stream with leftover oxygen from a portion of the second working fluid stream to produce a hot fluid stream and to inject the hot fluid stream into the second working fluid stream or to pass the hot fluid stream through the heat exchanger.

39. The temperature-control system of claim 34, wherein the heat exchanger comprises a plurality of heat exchangers in series and wherein the exothermic reactor comprises a deoxygenation reactor to burn a second fuel stream with leftover oxygen from a portion of the second working fluid stream withdrawn between a first of the plurality of heat exchangers and a last of the plurality of heat exchangers to produce a hot fluid stream and to inject the hot fluid stream into the second working fluid stream or to pass the hot fluid stream through one of the plurality of heat exchangers.

40. A system for handling transient conditions in an oxy-fuel combustion system, comprising a fuel flow control device to vary a flow rate mF of a fuel stream;
an oxygen flow control device to vary a flow rate mO of an oxygen fluid stream;
a combustor to receive an oxidant stream and the fuel stream and to combust the fuel stream with the oxidant stream to produce a first working fluid stream at a temperature T1, wherein the oxidant stream comprises a product working fluid stream and the oxygen fluid stream;
a turboexpander to receive the first working fluid stream and to produce work and a second working fluid stream at a temperature T2;
a heat exchanger to receive the second working fluid stream at a temperature T3 and cool the second working fluid stream by indirect contact heat exchange against one or more coolant streams, one of the one or more coolant streams comprising the oxidant stream, and to produce the product working fluid stream;
a first flow control device to vary a flow rate m1 of a first temperature control fluid stream into the combustor, wherein the first temperature control fluid stream comprises a first portion of the product working fluid stream and comprises one of the one or more coolant streams;
a second flow control device to vary a flow rate m2 of a second temperature control fluid stream into the turboexpander, wherein the first temperature control fluid stream comprises a second portion of the product working fluid stream and comprises one of the one or more coolant streams;
a third flow control device to vary a flow rate m3 of a third temperature control fluid stream into the second working fluid stream upstream of the heat exchanger, wherein the third temperature control fluid stream comprises a third portion of the product working fluid stream; and
a controller to:
calculate a rate of change of T3 (ΔT3); and
control one or more of m1, m2, and m3 to: (i) maintain a change in T3 (ΔT3) at a sufficiently low value to avoid damaging the heat exchanger, (ii) maintain T1 at a sufficiently high value to maintain flame in the combustor, and (iii) maintain T2 at a sufficiently low value to avoid damaging the turboexpander.

41. The system of claim 40, the controller further to keep ΔT3 below 4 °C/min by varying m1, m2, m3, mO, and/or mF within constraints that T1 remains above 700 °C but below 950 °C and T2 remains less than 600 °C.

42. The system of claim 40, the controller further to keep ΔT3 below 10 °C/min by varying m1, m2, m3, mO, and/or mF within constraints that T1 remains above 600 °C but below 1050 °C and T2 remains less than 700 °C.

43. The system of claim 40, the controller to bring the flow of m3 to zero when T3 equals T2.

44. The system of claim 40, further comprising a first temperature detection device to measure the temperature T1 and to transmit the temperature T1 to a controller.

45. The system of claim 40, further comprising a second temperature detection device to measure the temperature T2 and to transmit the temperature T2 to the controller.

46. The system of claim 40, further comprising a third temperature detection device to measure a temperature T3 of the second working fluid stream at an entrance to the heat exchanger.

47. A method for controlling temperature of a combustion system, the combustion system comprising a combustor combusting a fuel stream with an oxidant stream, producing a first working fluid stream at a temperature T1, a turboexpander using the first working fluid stream, generating work and a second working fluid stream at a temperature T2, and a heat exchanger receiving the second working fluid stream at a temperature T3 and cooling the second working fluid stream, generating a product working fluid stream, the method comprising:
controlling a flow of a first temperature control stream (m1) to the combustor;
controlling a flow of a second temperature control stream (m2) to the turboexpander;
controlling a flow of a third temperature control stream (m3) to the heat exchanger;
calculating a rate of change of T3 (ΔT3); and
controlling one or more of m1, m2, and m3 to: (i) maintain ΔT3 at a sufficiently low value to avoid damaging the heat exchanger, (ii) maintain T1 at a sufficiently high value to maintain flame in the combustor, and (iii) maintain T2 at a sufficiently low value to avoid damaging the turboexpander.

48. The method of claim 47, further comprising controlling a flow of the fuel stream (mF) to the combustor.

49. The method of claim 48, further comprising controlling a flow of the oxidant stream (mO) to the combustor.

50. The method of claim 49, wherein the combustor comprises an oxy-fuel combustor.

51. The method of claim 49, further comprising maintaining an equivalence ratio between the fuel stream and the oxidant stream in the combustor.

52. The method of claim 49, further comprising controlling mF, mO, or both mF and mO, to maintain a flame temperature Tflame before mixing mF and mO with m1.

53. The method of claim 47, wherein at least two of the first temperature control stream, the second temperature control stream, and the third temperature control stream comprise portions of a coolant stream.

54. The method of claim 53, wherein the coolant stream is at a temperature of at most 300 °C, at most 400 °C, or at most 500 °C.

55. The method of claim 47, further comprising cooling the second working fluid stream by indirect contact heat exchange against a coolant stream in the heat exchanger.

56. The method of claim 55, wherein the coolant stream comprises the product working fluid stream.

57. The method of claim 47, further comprising cooling the second working fluid stream by indirect contact heat exchange against the oxidant stream in the heat exchanger.

58. The method of claim 47, further comprising one or more of:
measuring T1 and transmitting T1 for use in calculating ΔT3;
measuring T2 and transmitting T2 for use in calculating ΔT3; and
measuring T3 and transmitting T3 for use in calculating ΔT3.

59. The method of claim 47, further comprising simulating or calculating one or more of T1, T2, and T3.

60. The method of claim 47, further comprising maintaining T1 above a fuel auto-ignition temperature.

61. The method of claim 47, further comprising maintaining ΔT3 at less than about 20 °C/min.

62. The method of claim 47, further comprising maintaining ΔT3 at less than about 10 °C/min.

63. The method of claim 47, further comprising maintaining ΔT3 at less than about 4 °C/min.

64. The method of claim 47, further comprising maintaining T1 at about 700-950 °C.

65. The method of claim 47, further comprising maintaining T1 at about 600-1200 °C.

66. The method of claim 47, further comprising maintaining T2 at less than about 600 °C.

67. The method of claim 47, further comprising maintaining T2 between 600 °C and 700 °C.

68. The method of claim 47, further comprising calculating T2 between any of n stages of a turboexpander.

69. The method of claim 47, further comprising spinning the turboexpander at a speed by an external motor.

70. The method of claim 69, further comprising overcoming losses in the turboexpander by the external motor.

71. The method of claim 70, further comprising increasing m2 to reduce T2.

72. The method of claim 47, further comprising bringing flow of m3 to zero when T3 equals T2.

73. The method of claim 47, further comprising keeping T3 less than T2.

74. The method of claim 47, wherein m1, m2, and m3 are from a same source.

75. The method of claim 47, wherein increasing m1 decreases m2, m3, or both m2 and m3.

76. The method of claim 47, wherein increasing m2 decreases m1, m3, or both m1 and m3.

77. The method of claim 47, wherein increasing m3 decreases m1, m2, or both m1 and m2.

78. The method of claim 47, wherein, post-ignition, the combustor combusts the fuel stream with the oxidant stream in the presence of a portion of a recycle CO2 (reCO2) stream, and wherein, pre-ignition, the combustion system further comprises an exothermic reactor to pre-heat the reCO2 stream, the oxidant stream, the product working fluid stream, or combinations thereof.

79. The method of claim 78, wherein the exothermic reactor is selected from the group consisting of a Sabatier reactor, a water-gas shift reactor, and a deoxygenation reactor.

80. The method of claim 78, wherein the exothermic reactor comprises a deoxygenation reactor to burn a second fuel stream with a portion of the oxidant stream to produce a hot fluid stream and to inject the hot fluid stream into the oxidant stream.

81. The method of claim 78, wherein the exothermic reactor comprises a Sabatier reactor, the Sabatier reactor to receive a portion of the reCO2 stream, the product working fluid stream comprising carbon dioxide, and to receive a hydrogen stream to produce a hot methane stream and to inject the hot methane stream into the reCO2 stream.

82. The method of claim 78, wherein the exothermic reactor comprises a deoxygenation reactor to burn a second fuel stream with leftover oxygen from a portion of the second working fluid stream to produce a hot fluid stream and to inject the hot fluid stream into the second working fluid stream or to pass the hot fluid stream through the heat exchanger.

83. The method of claim 78, wherein the heat exchanger comprises a plurality of heat exchangers in series and wherein the exothermic reactor comprises a deoxygenation reactor to burn a second fuel stream with leftover oxygen from a portion of the second working fluid stream withdrawn between a first of the plurality of heat exchangers and a last of the plurality of heat exchangers to produce a hot fluid stream and to inject the hot fluid stream into the second working fluid stream or to pass the hot fluid stream through one of the plurality of heat exchangers.

84. A system for controlling a combustion system, the combustion system comprising a combustor to combust a first fuel stream with an oxidant stream to produce a first working fluid stream, a turboexpander to use the first working fluid stream to generate work and a second working fluid stream, and a heat exchange system to receive the second working fluid stream and to cool the second working fluid stream to generate a product working fluid stream, the system comprising:
a deoxygenation reactor to receive a portion of the second working fluid stream and a second fuel stream, the second fuel stream provided at a flow rate sufficient to react with oxygen in the second working fluid stream, resulting in a third working fluid stream; and
the heat exchange system to receive the third working fluid stream and to cool the third working fluid stream.

85. The system of claim 84, wherein the heat exchange system comprises an oxidant heat exchanger to heat the oxidant stream against the third working fluid stream.

86. The system of claim 84, wherein the heat exchange system comprises a recycle CO2 heat exchanger to heat the oxidant stream against the third working fluid stream.

87. The system of claim 84, wherein:
the heat exchange system comprises a first heat exchanger and a second heat exchanger in series;
the portion of the second working fluid stream is drawn from between the first heat exchanger and the second heat exchanger; and
the third working fluid stream is passed to the second heat exchanger.

88. A system for controlling a combustion system, the combustion system comprising a combustor to combust a fuel stream with an oxidant stream in the presence of a recycle CO2 (reCO2) stream to produce a first working fluid stream, a turboexpander to use the first working fluid stream to generate work and a second working fluid stream, and a heat exchange system to receive the second working fluid stream and to cool the second working fluid stream to generate a product working fluid stream, the system comprising:
a Sabatier reactor to receive a portion of the reCO2 stream and a hydrogen stream to produce a hot methane stream, and to inject the hot methane stream into the reCO2 stream.

89. A system for controlling a combustion system, the combustion system comprising a combustor to combust a fuel stream with an oxidant stream in the presence of a recycle CO2 (reCO2) stream to produce a first working fluid stream, a turboexpander to use the first working fluid stream to generate work and a second working fluid stream, and a heat exchange system to receive the second working fluid stream and to cool the second working fluid stream to generate a product working fluid stream, the system comprising:
a Sabatier reactor to receive a portion of a secondary CO2 stream and a hydrogen stream to produce a hot methane stream, and to inject the hot methane stream into the secondary CO2 stream, wherein the secondary CO2 stream cools the turboexpander.
